(19) United States
(12) Patent Application Publication
(10) Pub. No.: US 2025/0324148 A1
(43) Pub. Date: Oct. 16, 2025

(54) COMMUNICATION SYSTEM AND COMMUNICATION METHOD

(71) Applicant: HTC Corporation, Taoyuan City (TW)

(72) Inventors: Chun-Yih WU, Taoyuan City (TW); Ta-Chun PU, Taoyuan City (TW); Yen-Liang KUO, Taoyuan City (TW)

(73) Assignee: HTC Corporation, Taoyuan City (TW)

(21) Appl. No.: 18/665,896

(22) Filed: May 16, 2024

(30) Foreign Application Priority Data
Apr. 15, 2024 (TW) 113113924

(51) Int. Cl. H04N 23/45; G02C 7/04; G06T 5/50; G06T 7/593; H01Q 1/27; H04N 23/55

(52) U.S. Cl. CPC H04N 23/45; G06T 5/50; G06T 7/593; G02C 7/04; G06T 2207/20221; H01Q 1/273; H04N 23/55

(57) ABSTRACT

A communication system includes a first contact lens element and a second contact lens element. The first contact lens element includes a first image capturer, a first HBC (Human Body Communication) module, and a processor. The first image capturer captures a first image data. The processor is coupled to the first image capturer and the first HBC module. The second contact lens element includes a second image capturer and a second HBC module. The second image capturer captures a second image data. The second HBC module is coupled to the second image capturer. The second HBC module transmits the second image data to the first HBC module. The processor generates a viewing angle differential data according to the first image data and the second image data.

### CROSS REFERENCE TO RELATED APPLICATIONS

This application claims priority of Taiwan Patent Application No. 113113924 filed on Apr. 15, 2024, the entirety of which is incorporated by reference herein.

### BACKGROUND OF THE INVENTION

### Field of the Invention

The invention relates to a communication system, and more particularly, to a communication system and a communication method.

### Description of the Related Art

When applied in the field of VR (Virtual Reality) or AR (Augmented Reality), a general communication system usually has problems with poor quality data transmission. Accordingly, there is a need to propose a novel solution for solving the problem of the prior art.

### BRIEF SUMMARY OF THE INVENTION

In an exemplary embodiment, the invention is directed to a communication system that includes a first contact lens element and a second contact lens element. The first contact lens element includes a first image capturer, a first HBC (Human Body Communication) module, and a processor. The first image capturer captures a first image data. The processor is coupled to the first image capturer and the first HBC module. The second contact lens element includes a second image capturer and a second HBC module. The second image capturer captures a second image data. The second HBC module is coupled to the second image capturer. The second HBC module transmits the second image data to the first HBC module. The processor generates a viewing angle differential data according to the first image data and the second image data.

In some embodiments, when the first contact lens element communicates with the second contact lens element, both the first HBC module and the second HBC module use a first HBC operational frequency band.

In some embodiments, the first HBC operational frequency band is from 60 MHz to 100 MHz.

In some embodiments, the communication system further includes a computing device for receiving and processing the first image data and the viewing angle differential data.

In some embodiments, the computing device includes a third HBC module and an image processing module. The third HBC module receives the first image data and the viewing angle differential data from the first HBC module. The image processing module is coupled to the third HBC module. The image processing module generates display information according to the first image data and the viewing angle differential data.

In some embodiments, when the first contact lens element communicates with the computing device, both the first HBC module and the third HBC module use a second HBC operational frequency band. The second HBC operational frequency band is different from the first HBC operational frequency band.

In some embodiments, the second HBC operational frequency band is from 10 MHz to 50 MHz.

In some embodiments, the first contact lens element further includes a first wireless communication module coupled to the processor. The computing device further includes a second wireless communication module coupled to the image processing module. The second wireless communication module transmits the display information to the first wireless communication module.

In some embodiments, the first contact lens element further includes a first display device coupled to the first wireless communication module. The first display device displays a target image according to the display information.

In some embodiments, the second contact lens element further includes a second display device coupled to the second HBC module. The second HBC module receives the display information from the first HBC module. The second display device displays the target image according to the display information.

In another exemplary embodiment, the invention is directed to a communication method that includes the steps of: providing a first contact lens element and a second contact lens element, wherein the first contact lens element includes a first image capturer, a first HBC module and a processor, and wherein the second contact lens element includes a second image capturer and a second HBC module; capturing a first image data by the first image capturer; capturing a second image data by the second image capturer; transmits the second image data to the first HBC module by the second HBC module; and generating a viewing angle differential data by the processor according to the first image data and the second image data.

In some embodiments, the communication method further includes: when the first contact lens element communicates with the second contact lens element, using a first HBC operational frequency band by both the first HBC module and the second HBC module.

In some embodiments, the communication method further includes: receiving and processing the first image data and the viewing angle differential data by a computing device.

In some embodiments, the communication method further includes: receiving the first image data and the viewing angle differential data from the first HBC module by a third HBC module of the computing device; and generating display information by an image processing module of the computing device according to the first image data and the viewing angle differential data.

In some embodiments, the communication method further includes: when the first contact lens element communicates with the computing device, using a second HBC operational frequency band by both the first HBC module and the third HBC module. The second HBC operational frequency band is different from the first HBC operational frequency band.

In some embodiments, the communication method further includes:
transmitting the display information to a first wireless communication module of the first contact lens element by a second wireless communication module of the computing device.

In some embodiments, the communication method further includes: displaying a target image by a first display device of the first contact lens element according to the display information.

In some embodiments, the communication method further includes: receiving the display information from the first HBC module by the second HBC module; and displaying the target image by a second display device of the second contact lens element according to the display information.

### BRIEF DESCRIPTION OF DRAWINGS

The invention can be more fully understood by reading the subsequent detailed description and examples with references made to the accompanying drawings, wherein:

FIG. 1 is a diagram of a communication system according to an embodiment of the invention;

FIG. 2 is a diagram of a communication system according to an embodiment of the invention; and

FIG. 3 is a flowchart of a communication method according to an embodiment of the invention.

### DETAILED DESCRIPTION OF THE INVENTION

In order to illustrate the foregoing and other purposes, features and advantages of the invention, the embodiments and figures of the invention will be described in detail as follows.

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. The term “substantially” means the value is within an acceptable error range. One skilled in the art can solve the technical problem within a predetermined error range and achieve the proposed technical performance. Also, the term “couple” is intended to mean either an indirect or direct electrical connection. Accordingly, if one device is coupled to another device, that connection may be through a direct electrical connection, or through an indirect electrical connection via other devices and connections.

The following disclosure provides many different embodiments, or examples, for implementing different features of the subject matter provided. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

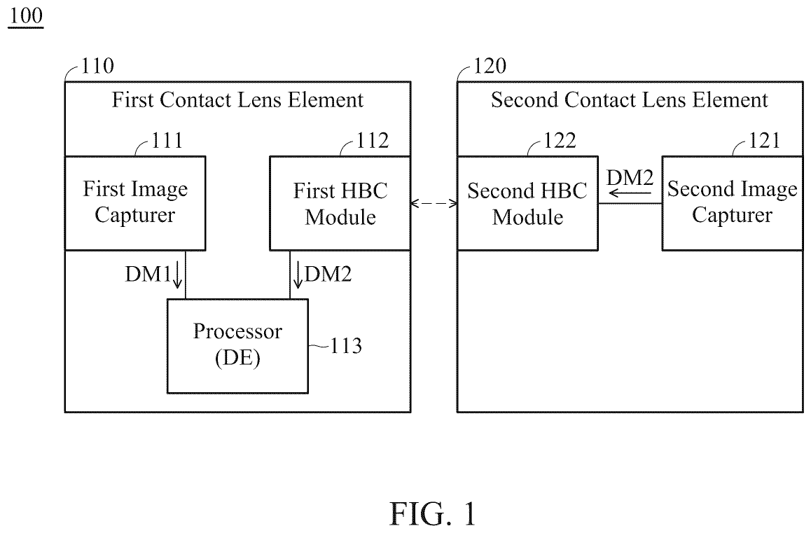

FIG. 1 is a diagram of a communication system 100 according to an embodiment of the invention. For example, the communication system 100 may be applied to the field of VR (Virtual Reality) or AR (Augmented Reality), but it is not limited thereto. As shown in FIG. 1, the communication system 100 at least includes a first contact lens element 110 and a second contact lens element 120.

In some embodiments, the first contact lens element 110 and the second contact lens element 120 are operated according to a master-slave control mechanism. The second contact lens element 120 can be directly or indirectly controlled by the first contact lens element 110. That is, the first contact lens element 110 may be considered as a master element, and the second contact lens element 120 may be considered as a slave element.

The first contact lens element 110 includes a first image capturer 111, a first HBC (Human Body Communication) module 112, and a processor 113. For example, the first image capturer 111 may be implemented with a camera element. The first image capturer 111 can capture a first image data DM1. The processor 113 is coupled to the first image capturer 111 and the first HBC module 112.

The second contact lens element 120 includes a second image capturer 121 and a second HBC module 122. For example, the second image capturer 121 may be implemented with another camera element. The second image capturer 121 can capture a second image data DM2. The second HBC module 122 is coupled to the second image capturer 121. It should be understood that each of the first contact lens element 110 and the second contact lens element 120 may include other components, such as a transmission line, a signal source, an antenna element, an electrode, a battery, and/or a power supply module, although they are not displayed in FIG. 1.

The first contact lens element 110 and the second contact lens element 120 can communicate with each other through the first HBC module 112 and the second HBC module 122. The second HBC module 122 can transmit the second image data DM2 to the first HBC module 112. Next, the processor 113 can generate a viewing angle differential data DE according to the first image data DM1 and the second image data DM2. For example, the first image data DM1 may correspond to a left-eye image of a user, and the second image data DM2 may correspond to a right-eye image of the user, but they are not limited thereto. Specifically, the processor 113 can compare the first image data DM1 with the second image data DM2, and then can determine the aforementioned viewing angle differential data DE according to the difference therebetween.

According to practical measurements, since the first contact lens element 110 and the second contact lens element 120 uses a human body as a transmission medium for transmission of a variety of data via an HBC mechanism, the overall communication quality and the data accuracy can be significantly increased. In addition, the generation of the viewing angle differential data DE can help to improve the following data compression and the corresponding transmission efficiency.

The following embodiments will introduce different configurations and detail structural features of the communication system 100. It should be understood that these figures and descriptions are merely exemplary, rather than limitations of the invention.

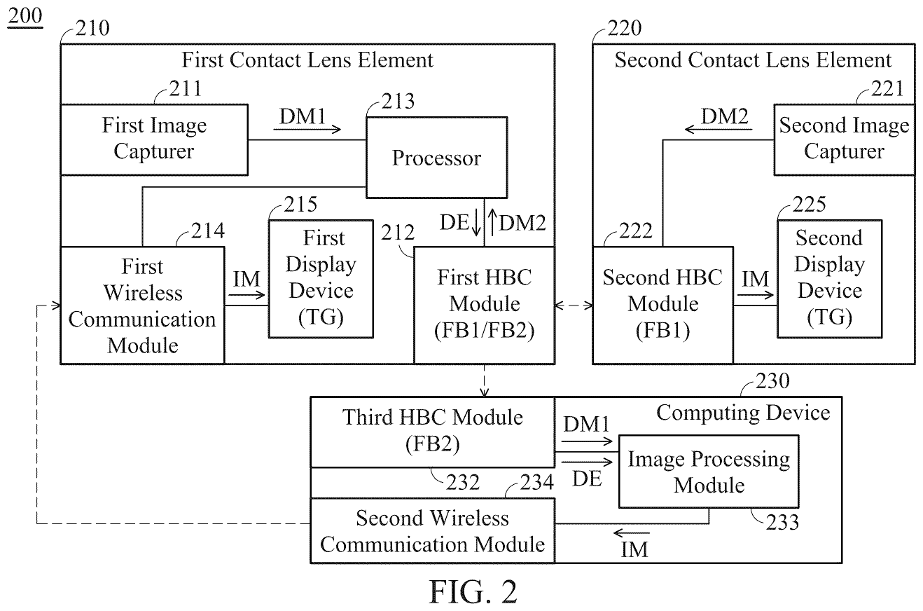

FIG. 2 is a diagram of a communication system 200 according to an embodiment of the invention. FIG. 2 is similar to FIG. 1. In the embodiment of FIG. 2, the communication system 200 includes a first contact lens element 210, a second contact lens element 220, and a computing device 230. The second contact lens element 220 can be directly or indirectly controlled by the first contact lens element 210. For example, the computing device 230 may be implemented with a mobile device, such as a smart phone, a tablet computer, or a notebook computer.

The first contact lens element 210 includes a first image capturer 211, a first HBC module 212, a processor 213, a first wireless communication module 214, and a first display device 215. The first image capturer 211 can capture a first image data DM1. The processor 213 is coupled to the first image capturer 211, the first HBC module 212, and the first wireless communication module 214. For example, the first wireless communication module 214 may be a Bluetooth module or a Wi-Fi module, but it is not limited thereto.

The second contact lens element 220 includes a second image capturer 221, a second HBC module 222, and a second display device 225. The second image capturer 221 can capture a second image data DM2. The second HBC module 222 is coupled to the second image capturer 221 and the second display device 225.

The first contact lens element 210 and the second contact lens element 220 can communicate with each other through the first HBC module 212 and the second HBC module 222. In some embodiments, when the first contact lens element 210 communicates with the second contact lens element 220, both the first HBC module 212 and the second HBC module 222 use a first HBC operational frequency band FB1. For example, the first HBC operational frequency band may be from 60 MHz to 100 MHz, but it is not limited thereto. The second HBC module 222 can transmit the second image data DM2 to the first HBC module 212. Next, the processor 213 can generate a viewing angle differential data DE according to the first image data DM1 and the second image data DM2. Then, the processor 213 can use the first HBC module 212 to transmit the first image data DM1 and the viewing angle differential data DE to the computing device 230.

Generally, the computing device 230 can receive and process the first image data DM1 and the viewing angle differential data DE. It should be understood that because the computing device 230 does not need to receive the second image data DM2, the overall amount of data transmission of the communication system 200 can be further reduced. However, the computing device 230 can still estimate the second image data DM2 according to the first image data DM1 and the viewing angle differential data DE. Specifically, the computing device 230 includes a third HBC module 232, an image processing module 233, and a second wireless communication module 234. The image processing module 233 is coupled to the third HBC module 232 and the second wireless communication module 234. For example, the second wireless communication module 234 may be another Bluetooth module or another Wi-Fi module, but it is not limited thereto.

The third HBC module 232 can receive the first image data DM1 and the viewing angle differential data DE from the first HBC module 212. In some embodiments, when the first contact lens element 210 communicates with the computing device 230, both the first HBC module 212 and the third HBC module 232 use a second HBC operational frequency band FB2. The second HBC operational frequency band FB2 may be different from the first HBC operational frequency band FB1. For example, the second HBC operational frequency band FB2 may be from 10 MHz to 50 MHz, but it is not limited thereto. With such a design, even if the first HBC module 212 is shared, the data transmission of the second HBC operational frequency band FB2 may not interfere with that of the first HBC operational frequency band FB1. In alternative embodiments, instead, the processor 213 can use the first wireless communication module 214 to transmit the first image data DM1 and the viewing angle differential data DE to the second wireless communication module 234.

The image processing module 233 can generate display information IM according to the first image data DM1 and the viewing angle differential data DE. For example, the display information IM may include the distance, the object identification, the object tracking, and/or general AR related information, but it is not limited thereto. Then, the image processing module 233 can use the second wireless communication module 234 to transmit the display information IM to the first wireless communication module 214.

In the first contact lens element 210, the first display device 215 can obtain the display information IM from the first wireless communication module 214. The first display device 215 can display a target image TG according to the display information IM. Next, the processor 213 can use the first HBC module 212 to transmit the display information IM to the second contact lens element 220.

In the second contact lens element 220, the second HBC module 222 can receive the display information IM from the first HBC module 212. The first display device 225 can obtain the display information IM from the second HBC module 222. The second display device 225 can display the aforementioned target image TG according to the display information IM. In other words, the first display device 215 and the second display device 225 can perform a synchronized display process, so as to improve the actual visual experience of users. It should be noted that since the second contact lens element 220 is substantially controlled by the first contact lens element 210, the computing resources of the communication system 200 can be further saved, thereby reducing the overall power consumption.

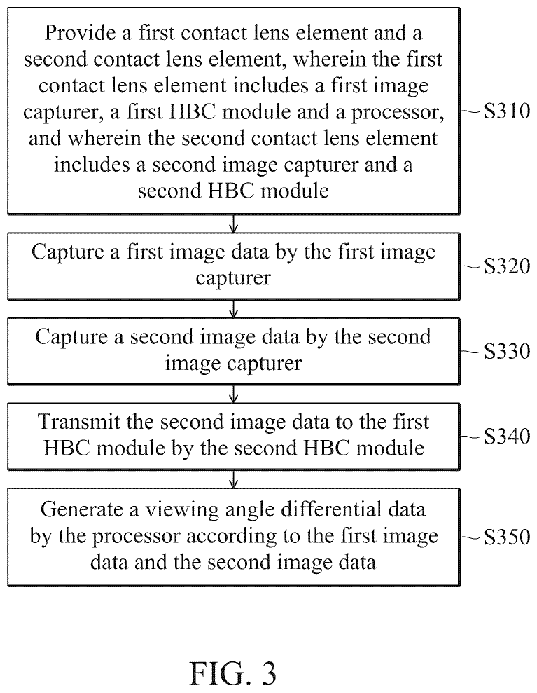

FIG. 3 is a flowchart of a communication method according to an embodiment of the invention. To begin, in step S310, a first contact lens element and a second contact lens element are provided. The first contact lens element includes a first image capturer, a first HBC module, and a processor. The second contact lens element includes a second image capturer and a second HBC module. In step S320, a first image data is captured by the first image capturer. In step S330, a second image data is captured by the second image capturer. In step S340, the second image data is transmitted to the first HBC module by the second HBC module. Finally, in step S350, a viewing angle differential data is generated by the processor according to the first image data and the second image data. It should be understood that these steps are not required to be performed in order, and every feature of the embodiments of FIGS. 1 and 2 may be applied to the communication method of FIG. 3.

The invention proposes a novel communication system and a novel communication method thereof. In comparison to the conventional design, the invention has at least the advantages of improving the communication quality, increasing the transmission efficiency, saving the computing resources, and reducing the signal interference. Therefore, the invention is suitable for application in a variety of devices.

It should be noted that the above element parameters are not limitations of the invention. A designer can fine-tune these setting values according to different requirements. The communication system and the communication method of the invention are not limited to the configurations of FIGS. 1-3. The invention may include any one or more features of any one or more embodiments of FIGS. 1-3. In other words, not all of the features displayed in the figures should be implemented in the communication system and the communication method of the invention.

The method of the invention, or certain aspects or portions thereof, may take the form of program code (i.e., executable instructions) embodied in tangible media, such as floppy diskettes, CD-ROMS, hard drives, or any other machine-readable storage medium, wherein, when the program code is loaded into and executed by a machine such as a computer, the machine thereby becomes an apparatus for practicing the methods. The methods may also be embodied in the form of program code transmitted over some transmission medium, such as electrical wiring or cabling, through fiber optics, or via any other form of transmission, wherein, when the program code is received and loaded into and executed by a machine such as a computer, the machine becomes an apparatus for practicing the disclosed methods. When implemented on a general-purpose processor, the program code combines with the processor to provide a unique apparatus that operates analogously to application-specific logic circuits.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

It will be apparent to those skilled in the art that various modifications and variations can be made in the invention. It is intended that the standard and examples be considered as exemplary only, with a true scope of the disclosed embodiments being indicated by the following claims and their equivalents.

What is claimed is:

1. A communication system, comprising:
a first contact lens element, comprising:
a first image capturer, capturing a first image data;
a first HBC (Human Body Communication) module; and
a processor, coupled to the first image capturer and the first HBC module; and
a second contact lens element, comprising:
a second image capturer, capturing a second image data; and
a second HBC module, coupled to the second image capturer, wherein the second HBC module transmits the second image data to the first HBC module;
wherein the processor generates a viewing angle differential data according to the first image data and the second image data.

2. The communication system as claimed in claim 1, wherein when the first contact lens element communicates with the second contact lens element, both the first HBC module and the second HBC module use a first HBC operational frequency band.

3. The communication system as claimed in claim 2, wherein the first HBC operational frequency band is from 60 MHz to 100 MHz.

4. The communication system as claimed in claim 2, further comprising:
a computing device, receiving and processing the first image data and the viewing angle differential data.

5. The communication system as claimed in claim 4, wherein the computing device comprises:
a third HBC module, receiving the first image data and the viewing angle differential data from the first HBC module; and
an image processing module, coupled to the third HBC module, wherein the image processing module generates display information according to the first image data and the viewing angle differential data.

6. The communication system as claimed in claim 5, wherein when the first contact lens element communicates with the computing device, both the first HBC module and the third HBC module use a second HBC operational frequency band, and the second HBC operational frequency band is different from the first HBC operational frequency band.

7. The communication system as claimed in claim 6, wherein the second HBC operational frequency band is from 10 MHz to 50 MHz.

8. The communication system as claimed in claim 5, wherein the first contact lens element further comprises:
a first wireless communication module, coupled to the processor;
wherein the computing device further comprises:
a second wireless communication module, coupled to the image processing module, wherein the second wireless communication module transmits the display information to the first wireless communication module.

9. The communication system as claimed in claim 8, wherein the first contact lens element further comprises:
a first display device, coupled to the first wireless communication module, wherein the first display device displays a target image according to the display information.

10. The communication system as claimed in claim 9, wherein the second contact lens element further comprises:
a second display device, coupled to the second HBC module, wherein the second HBC module receives the display information from the first HBC module, and the second display device displays the target image according to the display information.

11. A communication method, comprising the steps of:
providing a first contact lens element and a second contact lens element, wherein the first contact lens element comprises a first image capturer, a first HBC module and a processor, and wherein the second contact lens element comprises a second image capturer and a second HBC module;
capturing a first image data by the first image capturer;
capturing a second image data by the second image capturer;
transmits the second image data to the first HBC module by the second HBC module; and
generating a viewing angle differential data by the processor according to the first image data and the second image data.

12. The communication method as claimed in claim 11, further comprising:
when the first contact lens element communicates with the second contact lens element, using a first HBC operational frequency band by both the first HBC module and the second HBC module.

13. The communication method as claimed in claim 12, wherein the first HBC operational frequency band is from 60 MHz to 100 MHz.

14. The communication method as claimed in claim 12, further comprising:
receiving and processing the first image data and the viewing angle differential data by a computing device.

15. The communication method as claimed in claim 14, further comprising:
receiving the first image data and the viewing angle differential data from the first HBC module by a third HBC module of the computing device; and
generating display information by an image processing module of the computing device according to the first image data and the viewing angle differential data.

16. The communication method as claimed in claim 15, further comprising:
when the first contact lens element communicates with the computing device, using a second HBC operational frequency band by both the first HBC module and the third HBC module, wherein the second HBC operational frequency band is different from the first HBC operational frequency band.

17. The communication method as claimed in claim 16, wherein the second HBC operational frequency band is from 10 MHz to 50 MHz.

18. The communication method as claimed in claim 15, further comprising:
transmitting the display information to a first wireless communication module of the first contact lens element by a second wireless communication module of the computing device.

19. The communication method as claimed in claim 18, further comprising:
displaying a target image by a first display device of the first contact lens element according to the display information.

20. The communication method as claimed in claim 19, further comprising:
receiving the display information from the first HBC module by the second HBC module; and
displaying the target image by a second display device of the second contact lens element according to the display information.
